(19) United States
(12) Patent Application Publication
(10) Pub. No.: US 2016/0364722 A1
(43) Pub. Date: Dec. 15, 2016

(54) ALTERNATE PRIMARY ACCOUNT NUMBER GENERATION

(71) Applicant: CA, Inc., New York, NY (US)

(72) Inventors: Pradeep G. NAIR, Bangalore (IN); Mahesh M. CHITRAGAR, Bangalore (IN); Vishwanatha SALIAN, Bangalore (IN)

(73) Assignee: CA, Inc.

(21) Appl. No.: 14/734,668

(22) Filed: Jun. 9, 2015

(51) Int. Cl. G06Q 20/38; G06Q 20/34; H04L 9/08; H04L 29/06; G06F 21/62; G06F 21/64

(52) U.S. Cl. CPC G06Q 20/3829; G06F 21/6245; G06F 21/64; H04L 9/0861; H04L 63/0428; G06Q 20/352

(57) ABSTRACT

A method for alternate primary account number generation is described. The method comprises receiving, from a device, an input data string containing sensitive data. The input data string comprises a first portion, a second portion, and a third portion. A plurality of values is generated using the second portion of the input data string, wherein each of the plurality of values are of a predetermined amount of numbers, each of the plurality of values having a corresponding key. A first key is selected, based on the second portion, from the plurality of values. A second key is generated using the first key. An output value is selected, based on the second key, from the plurality of values. An output data string is generated using the first portion, the output value, and the third portion.

### TECHNICAL FIELD

The present disclosure relates to contactless transactions and, in particular, to an apparatus, computer-readable medium, and method for generating an alternate primary account number.

### BACKGROUND

Credit cards have become an immensely popular method of payment for goods and services. As mobile devices have grown in popularity, consumers now desire the ability to complete transactions using mobile applications on mobile devices. To successfully complete a transaction, sensitive card data may be transferred to and from the mobile device. Considering the frequency of transactions, securing sensitive data while in storage or in transit is mandatory in today's climate.

There are several options to secure an account number. Encryption algorithms, for example, transform information using an algorithm to make it unreadable to anyone absent special knowledge, usually referred to as a key. However, encryption algorithms are dependent on protecting the key from public exposure. Furthermore, encryption algorithms are undesirable because they are reversible. Pseudorandom numbers can also be utilized to tokenize an account number, but this approach requires a significant amount of database lookups which are a time sink.

Accordingly, there is a need in the marketplace for a system designed to secure account numbers in storage or in transit. From an efficiency, security, and cost standpoint, the current disclosure provides an effective solution to this problem by using a pre-generated list of token numbers for a range of values to tokenize sensitive data during contactless transactions. Unlike encryption algorithms, this solution is irreversible. Additionally, this solution does not require any database lookups.

Embodiments of the present disclosure can address the above problems, and other problems, individually and collectively.

### SUMMARY

According to an embodiment of the present disclosure, a method comprising receiving, from a device, an input data string containing sensitive data The input data string comprises a first portion comprising a first predetermined amount of numbers, a second portion comprising a second predetermined amount of numbers, and a third portion comprising a third predetermined amount of numbers. The method further comprising generating a plurality of values using the second portion of the input data string, wherein each of the plurality of values are of the second predetermined amount of numbers, and wherein each of the plurality of values has a corresponding key. The method further comprising selecting a first key, based on the second portion, from the plurality of values. The method further comprising generating a second key using the first key, and using the second key to select an output value from the plurality of values. Finally, the method further comprising generating an output data string using the first portion, the output value, and the third portion.

According to another embodiment of the present disclosure, a computer configured to access a storage device, the computer comprising a processor, and a non-transitory, computer-readable storage medium storing computer-readable instructions that when executed by the processor cause the computer to perform the aforementioned method.

According to another embodiment of the present disclosure, a computer program product comprising a computer-readable storage medium having computer-readable program code embodied therewith, the computer-readable program comprising computer-readable program code configured to perform the aforementioned method.

Other objects, features, and advantages will be apparent to persons of ordinary skill in the art in view of the following detailed description and the accompanying drawings.

### BRIEF DESCRIPTION OF THE DRAWINGS

For a more complete understanding of the present disclosure, needs satisfied thereby, and the objects, features, and advantages thereof, reference now is made to the following description taken in connection with the accompanying drawings. Embodiments of the present disclosure, and their features and advantages, may be understood by referring to FIGS. 1-6, like numerals being used for corresponding parts in the various drawings.

FIG. 1 is a schematic representation of the communication ecosystem in accordance with a non-limiting embodiment of the present disclosure.

FIG. 2 is a schematic depiction of the communication between entities during token generation in accordance with a non-limiting embodiment of the present disclosure.

FIG. 3 is another schematic depiction of the communication between entities during a contactless mobile transaction in accordance with a non-limiting embodiment of the present disclosure.

FIG. 4 illustrates a chart and a schematic of an example of encryption and tokenization in a non-limiting embodiment of the present disclosure.

FIG. 5 illustrates a flow diagram of a method of tokenizing a primary account number of a credit card in accordance with a non-limiting embodiment of the present disclosure.

FIG. 6 illustrates a flow diagram of a method of tokenizing an input data string in accordance with a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Industries in today's climate face many challenges in receiving and transmitting vast amounts of sensitive data. One such challenge is promoting data security without dampening business. Moreover, global access in any industry increases the risk of a security breach. Aspects of the current disclosure relate to systems and methods for secure access and utilization of sensitive data via a tokenization process. Various embodiments of the present disclosure protect sensitive data, such as, for example, credit card numbers, account information, health records, Social Security Numbers, financial information, criminal records, driver and vehicle information, voter records, and any other personal or sensitive information that may be communicated, stored or processed in computer systems.

Tokenization is a process of replacing sensitive data with non-sensitive values referred to as tokens. Tokens bear enough information to be useful in communications without compromising security. In the present disclosure, the use of tokenization emphasizes security while minimizing the integration impact on existing infrastructure. In one of the preferred embodiments of the present disclosure, sensitive data from a credit card account may be replaced by a generated token distributed in place of the original data, in order to protect the cardholder's information.

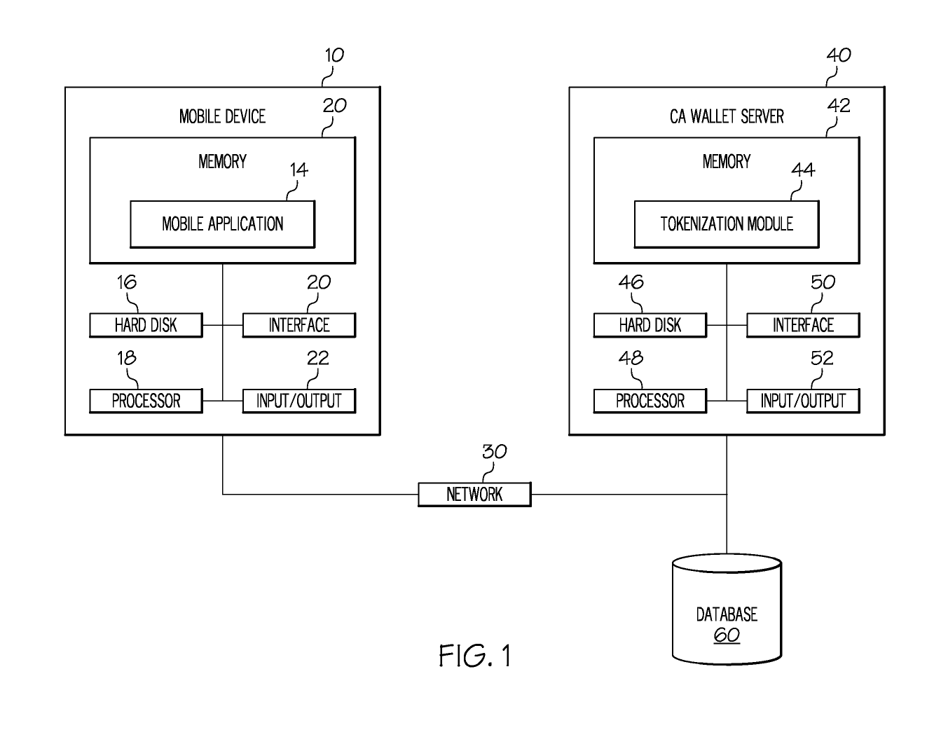

FIG. 1 is a schematic representation of the communication ecosystem in accordance with a non-limiting embodiment of the present disclosure. The communication ecosystem may include a mobile device 10, a network 30, a server 40, and a database 60. Further, the mobile device 10 can include a memory 12, application 14 (also referred to as ‘mobile application’ herein), input and output (“I/O”) device 22, hard disk 16, interface 20, and processor 18. Processor 18 may be operable to load instructions from hard disk 16 into memory 12 and execute those instructions. Memory 12 may store computer-readable instructions that may instruct the mobile device 10 to perform certain processes. I/O device 22 may receive one or more of data from server 40 or network 30.

Server 40 may, for example, be CA Wallet Server which can assist the mobile device 10 in mobile payments. The server 40 can include a memory 42, tokenization module 44, hard disk 46, interface 50, processor 48, and input and output (“I/O”) device 52. The server 40 may communicate with the mobile device 10 via a network 30. The server 40 may also communicate and transmit information to a database 60. Throughout this application, the server 40 may be represented by the CA wallet server in a non-limiting embodiment of the present disclosure.

Network 30 may comprise one or more entities, which may be public, private, or community based. Each network 30 may permit the exchange of information and services among users/entities that are connected to such network 30. In certain configurations, network 30 may be a local area network, such as an intranet. Further, network 30 may be a closed, private network/cloud in certain configurations, and an open network/cloud in other configurations. Network 30 may facilitate wired or wireless communications of information and provisioning of services among users that are connected to network 30.

The mobile device 10 may be enabled for near field communication (NFC) transactions via an antenna. The application 14 on the mobile device 10 may act as a control interface for the cardholder during a contactless transaction. The application 14 may be the means with which the cardholder prepares the mobile device 10 for contactless transaction and the means with which the cardholder receives a display of payment confirmation. The application 14 can also be the means with which the cardholder initiates a mobile transaction. According to an embodiment of the current disclosure, the application 14 can be a mobile application installed on the mobile device 10. The mobile device 10 refers to any device in any environment requiring generation of an alternate primary account number. The mobile device 10 may be a mobile telephone or cellular device, but the present disclosure is not bound by this non-limiting embodiment.

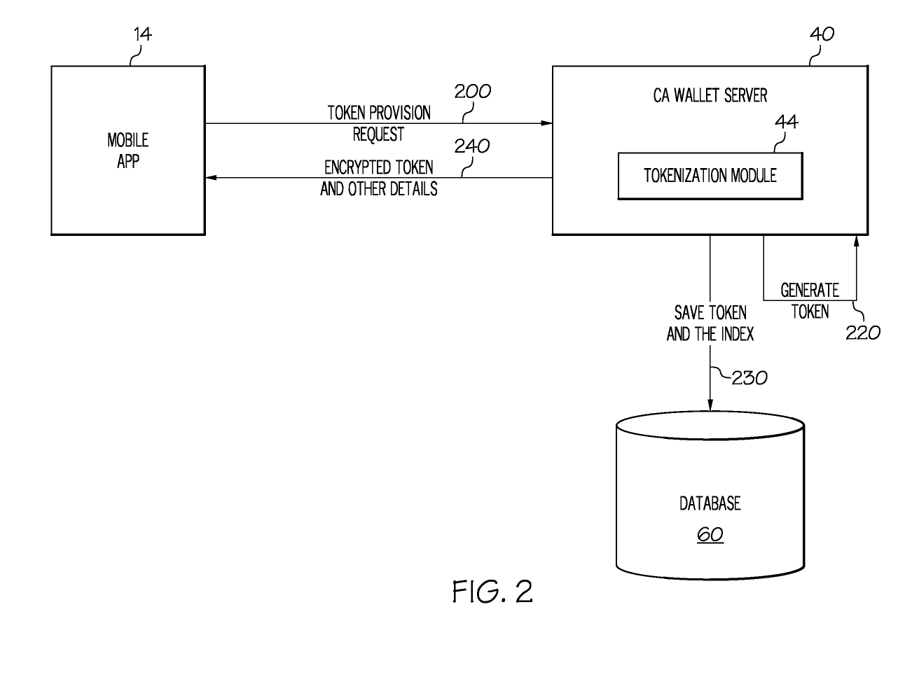

FIG. 2 is a schematic depiction of the communication between entities during token generation in accordance with a non-limiting embodiment of the present disclosure. In step 200, Mobile application 14 may transmit a token provision request to the server 40. In step 220, tokenization module 44 within the server 40 may generate a token by generating an index. The process of generating a token and index is subsequently described in detail. In step 230, the token and index is saved in a database 60. In step 240, the server 40 encrypts and transmits the token and other details to the mobile application 14 on the mobile device 10. Any data or information transmitted from the tokenization module 44 or CA wallet server 40 may be encrypted or protected in any manner.

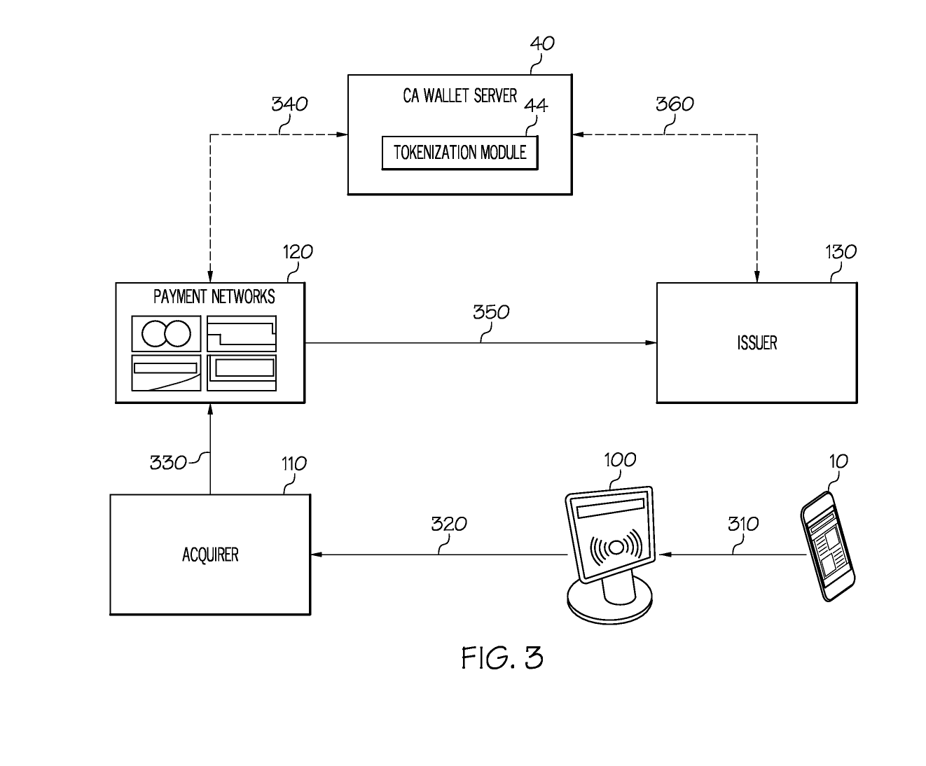

FIG. 3 is another schematic depiction of the communication between entities during a contactless mobile transaction in accordance with a non-limiting embodiment of the present disclosure. In step 310, Mobile device 10 initiates a contactless payment, such as NFC, at a point of sale (POS) 100. The application 14 may be the means with which the cardholder initiates a mobile transaction. In step 320, the NFC enabled POS 100 receives the tokenized account number and packages it as an authorization request. In step 320, the authorization request is transmitted from the NFC enabled POS 100 to the acquirer 110. In step 330, the acquirer 110 forwards the authorization request to a payment network 120.

In step 340, the payment network can contact the server 40 for de-tokenization and de-encryption of the sensitive data. The server 40 returns the decoded sensitive data to the payment network. In step 350, the payment network communicates the decoded authorization request with the issuer 130. Upon the issuer 130 approving the authorization request, an authorization response may then be sent back through the payment ecosystem to approve the contactless transaction. If the payment network 120 has not decoded the authorization request, the issuer 130 may communicate with the server 40 to decode the request, as shown in step 360.

The POS 100 may be active or passive. If the POS 100 is active, it is powered by electricity or another power source. If the POS 100 is passive, it does not require any electricity or power source, but can still communicate with a contactless enabled device by, for example, NFC electromagnetic induction. In addition, the POS 100 may also be a mobile device, a tablet, a computer system, a smartphone-based system, any other suitable receiving system, or any combination thereof.

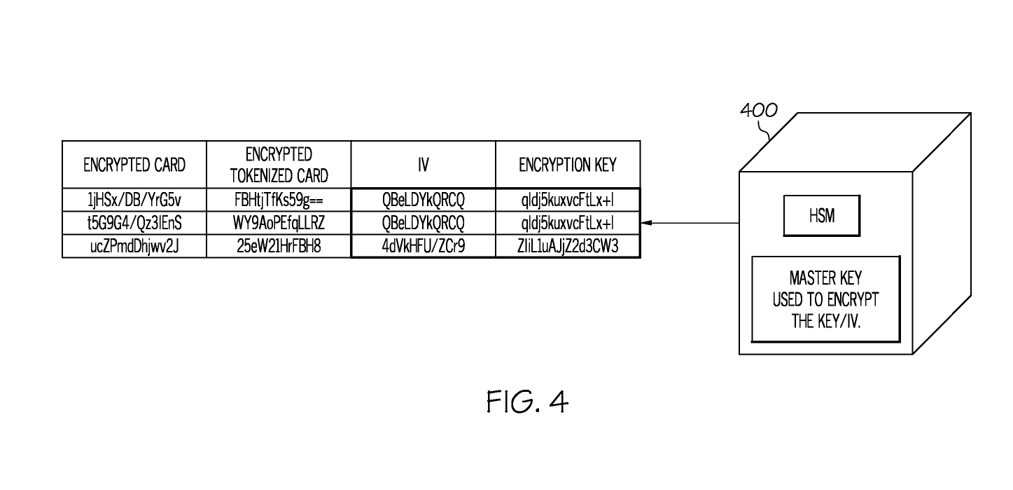

FIG. 4 illustrates a chart and a schematic of an example of encryption and tokenization in a non-limiting embodiment of the present disclosure. FIG. 4 depicts a hardware security module (HSM) 400 used to safeguard and manage encryption keys and initialization vectors (IV) for strong authentication. The HSM 400 also stores the master key. FIG. 4 also illustrates a chart of an example credit card account number encrypted, encrypted and tokenized, and the initialization vector and encryption key used for encryption. An initialization vector is an unpredictable random number used to ‘initialize’ an encryption function.

The amount of pairs of encryption keys and initialization vectors may vary based on the need of a bank. Also, a thousand pairs does not require a thousand encryption keys. Instead, ten keys and a hundred initialization vectors may be used. There may also be one master key per bank, stored in the HSM to encrypt the pair of encryption key and initialization vector. The pair may be generated on the fly and securely stored using the master key in the tokenization server, available during de-tokenization.

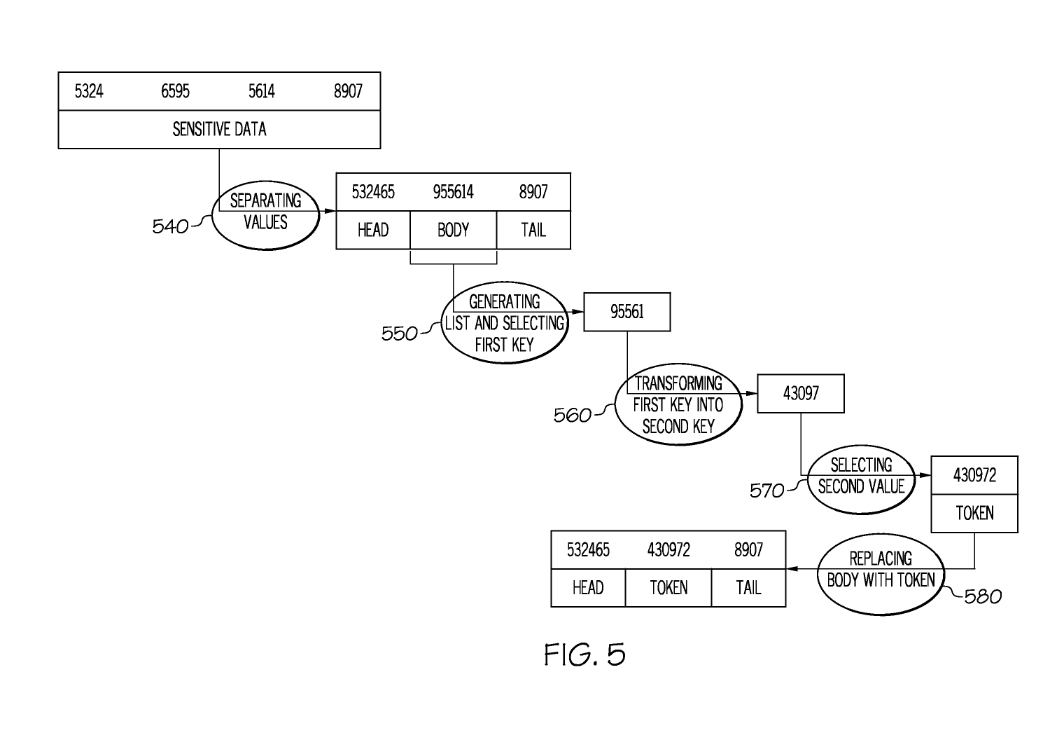

FIG. 5 illustrates a flow diagram of a method of tokenizing a primary account number of a credit card in accordance with a non-limiting embodiment of the present disclosure. The method of tokenizing sensitive data, such as a primary account number, is shown in FIG. 5 as a non-limiting embodiment of the present disclosure. In step 540, the sensitive data is split into three parts. A head portion comprises a first predetermined amount of values; in the present non-limiting embodiment, the head portion comprises six values. A body portion comprises a second predetermined amount of values; in the present non-limiting embodiment, the body portion also comprises six values. Finally, a tail portion comprises a third predetermined amount of values; in the present non-limiting embodiment, the tail portion comprises four values.

In this non-limiting embodiment, only the body portion of the card number is tokenized. There are several practical advantages to tokenizing only the body portion of the sequence.

For any credit card account number, the first digit in the sequence is the Major Industry Identifier (MII), which represents the category of entity which issued the card. For example, a first digit of ‘1’ indicates the airline industry. The first six digits (or head portion) of a credit card account number identify the bank, or issuer. By preserving the bank identifying value, the existing payment ecosystem can process the tokenized card number. In other words, the POS 100, acquirer 110, and payment network 120 can process the card number even after the body portion is tokenized.

Additionally, the the last four digits (or tail portion) of the sequence are preserved. These digits are commonly used by the cardholder to identify their account. For example, when the cardholder receives a receipt displaying the tail portion, the card holder will recognize which account was used. The card holder will not be aware that a tokenized account number was utilized instead of the standard account number.

To provide randomness to the tokenization technique, a format preserving encryption (FPE) algorithm is used. A FPE algorithm encrypts in such a way that the output is in the same format as the input. For example, if a six digit number is the input into a FPE algorithm, the algorithm will also output a six digit number. The FPE algorithm is collision free and irreversible.

In step 550, a list may be generated using the body portion of the account number. The list comprises all replacements for the body portion that will satisfy Luhn's check. Luhn's check is an authentication process used to verify, for example, that a credit card number is valid. The Luhn algorithm manipulates the entire number through a series of operations to detect any single-digit error. Luhn's check utilizes the last digit in the sequence as a checksum. This process is frequently used to validate mobile phone identification numbers, health care provider numbers, and insurance numbers. Using this checksum formula adds an additional layer of complexity and security for the tokenization process.

The following is a list, corresponding to FIG. 5, of all valid replacements for the body portion of the credit card number that will satisfy Luhn's check:

| Key | Value |
|---|---|
| [0] | 000007 |
| [1] | 000015 |
| [2] | 000023 |
| [3] | 000031 |
| [4] | 000049 |
| . . . | . . . |
| . . . | . . . |
| [43097] | 430972 |
| . . . | . . . |
| . . . | . . . |
| [95561] | 955614 |
| . . . | . . . |
| . . . | . . . |
| [99997] | 999976 |
| [99998] | 999984 |
| [99999] | 999992 |

In the present example, reflecting a non-limiting embodiment of the present disclosure, there are a total of 100,000 valid replacements for the body portion of the credit card number. When the body portion of the original credit card number is replaced by any one of these values, the credit card number will satisfy Luhn's check. Additionally, the generated list will vary according to each credit card number because the list comprises valid body replacements that satisfy Luhn's check. In other words, two cards with an equal values in a body portion will not generate the same list if there is variance in the head and tail values. As previously mentioned, tokenizing the number in this manner permits validation in the existing system, such as at the POS 100 or issuer 130 level.

In step 550, a first key will be selected from the list of values based on the body portion. In the current example, the body portion has a value of 955614. The system selects a first key of [95561] corresponding to the body portion value 955614. In step 560, the first key is considered the input into an FPE algorithm to produce an output of a unique five digit number, referred to as a second key. The encryption key and initialization vector pair used in the FPE will ensure that the tokens are not repeated and are unique and irreversible. For example, the FPE algorithm receives an input of the first key of [95561], and the algorithm generates an output of the second key of [43097]. The second key is then referenced in the list to select a token of 430972.

In step 580, the body portion of the credit card number is replaced with the token, as shown in FIG. 5. In order to increase the amount of iterations available, a different encryption key and initialization vector pair will be used for every combination of the head portion and tail portion. This will accommodate credit card numbers containing the same values for the body portion of the sequence. Although the credit card number may have the same body portion, a different encryption key and initialization vector is used, producing a different output. If the both the head and tail portions of two numbers are consistent, but the body portions are different, the system will use the same encryption key and initialization vector pair. However, if the body portions of two credit card numbers are different, the first key selected will also be different.

The encryption key and initialization vector may be unique based on the head and tail portions of the sequence. For every combination of the head portion and tail portion, there will be an encryption key and initialization vector pair. Theoretically there are 10̂10 encryption key and initialization vector pairs for a sixteen digit card number.

There is a situation in which the generated list may be identical for two different card numbers. Because Luhn's check doubles every other value in, for example, a credit card number, it is possible to manipulate undoubled values and still pass the checksum. In this case, however, the two card numbers will differ when the new token replaces the body portion of the original credit card number. More importantly, the encryption key and initialization vectors will vary even if an identical list is generated by two different credit card numbers.

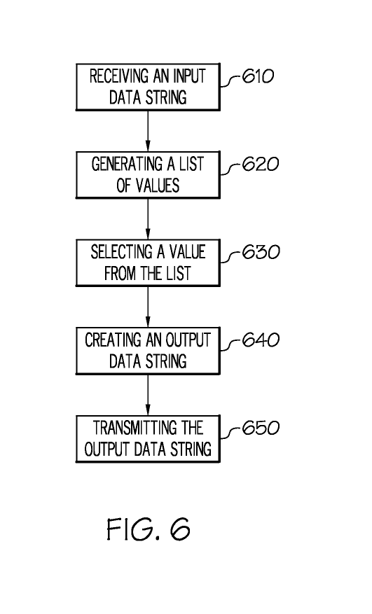

FIG. 6 illustrates a flow diagram of a method of tokenizing an input data string in accordance with a non-limiting embodiment of the present disclosure. In step 610, a system, such as, for example, the CA Wallet Server 40, receives an input data string. In step 620, a list of values is generated. In step 630, a value is selected from the list. In step 640, an output data string is created using the selected value. In step 650, the output data string is transmitted to a mobile device during, for example, a contactless NFC transaction.

The flowchart depicted in FIGS. 1-6 illustrates the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

While the present disclosure has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It will also be understood by those of ordinary skill in the art that the scope of the disclosure is not limited to use in a contactless transaction context, but rather that embodiments of the invention may be used in any transaction having a need to protect sensitive data of any type. The specification and the described examples are considered as exemplary only, with the true scope and spirit of the invention indicated by the following claims.

What is claimed is:

1. A method, comprising:
receiving, from a device, an input data string containing sensitive data, wherein the input data string comprises a first portion comprising a first predetermined amount of numbers, a second portion comprising a second predetermined amount of numbers, and a third portion comprising a third predetermined amount of numbers;
generating a plurality of values using the second portion of the input data string, wherein each of the plurality of values are of the second predetermined amount of numbers, wherein each of the plurality of values has a corresponding key;
selecting a first key, based on the second portion, from the plurality of values;
generating a second key using the first key;
selecting an output value, based on the second key, from the plurality of values; and
generating an output data string using the first portion, the output value, and the third portion.

2. The method of claim 1, wherein the input data string comprises a sixteen digit credit card number, wherein the first predetermined amount of numbers comprises a first six digits of the sixteen digit credit card number, wherein the second predetermined amount of numbers comprises a middle six digits of the sixteen digit credit card number, wherein the third predetermined amount of numbers comprises a last four digits of the sixteen digit credit card number; and
wherein the input data string passes a checksum validation and the output data string passes the checksum validation.

3. The method of claim 2, wherein the checksum validation comprises the Luhn algorithm.

4. The method of claim 1, wherein generating a second key using the first key comprises using a format preserving encryption algorithm.

5. The method of claim 1, wherein generating a second key using the first key further comprises using an encryption key and an initialization vector.

6. The method of claim 1, wherein the output data string is equal in length to the input data string.

7. The method of claim 1, further comprising:
encrypting the output data string; and
transmitting the output data string to the device.

8. A computer configured to access a storage device, the computer comprising:
a processor; and
a non-transitory, computer-readable storage medium storing computer-readable instructions that when executed by the processor cause the computer to perform:
receiving, from a device, an input data string containing sensitive data, wherein the input data string comprises a first portion comprising a first predetermined amount of numbers, a second portion comprising a second predetermined amount of numbers, and a third portion comprising a third predetermined amount of numbers;
generating a plurality of values using the second portion of the input data string, wherein each of the plurality of values are of the second predetermined amount of numbers, wherein each of the plurality of values has a corresponding key;
selecting a first key, based on the second portion, from the plurality of values;
generating a second key using the first key;
selecting an output value, based on the second key, from the plurality of values; and
generating an output data string using the first portion, the output value, and the third portion.

9. The computer of claim 8, wherein the input data string comprises a sixteen digit credit card number, wherein the first predetermined amount of numbers comprises a first six digits of the sixteen digit credit card number, wherein the second predetermined amount of numbers comprises a middle six digits of the sixteen digit credit card number, wherein the third predetermined amount of numbers comprises a last four digits of the sixteen digit credit card number; and
wherein the input data string passes a checksum validation and the output data string passes the checksum validation.

10. The computer of claim 9, wherein the checksum validation comprises the Luhn algorithm.

11. The computer of claim 8, wherein generating a second key using the first key comprises using a format preserving encryption algorithm.

12. The computer of claim 8, wherein generating a second key using the first key further comprises using an encryption key and an initialization vector.

13. The computer of claim 8, wherein the output data string is equal in length to the input data string.

14. The computer of claim 8, further comprising:
encrypting the output data string; and
transmitting the output data string to the device.

15. A computer program product comprising:
a computer-readable storage medium having computer-readable program code embodied therewith, the computer-readable program code comprising:
computer-readable program code configured to receive, from a device, an input data string containing sensitive data, wherein the input data string comprises a first portion comprising a first predetermined amount of numbers, a second portion comprising a second predetermined amount of numbers, and a third portion comprising a third predetermined amount of numbers;
computer-readable program code configured to generate a plurality of values using the second portion of the input data string, wherein each of the plurality of values are of the second predetermined amount of numbers, wherein each of the plurality of values has a corresponding key;
computer-readable program code configured to select a first key, based on the second portion, from the plurality of values;
computer-readable program code configured to generate a second key using the first key;
computer-readable program code configured to select an output value, based on the second key, from the plurality of values; and
computer-readable program code configured to generate an output data string using the first portion, the output value, and the third portion.

16. The computer program product of claim 15, wherein the input data string comprises a sixteen digit credit card number, wherein the first predetermined amount of numbers comprises a first six digits of the sixteen digit credit card number, wherein the second predetermined amount of numbers comprises a middle six digits of the sixteen digit credit card number, wherein the third predetermined amount of numbers comprises a last four digits of the sixteen digit credit card number; and
wherein the input data string passes a checksum validation and the output data string passes the checksum validation.

17. The computer program product of claim 16, wherein the checksum validation comprises the Luhn algorithm.

18. The computer program product of claim 15, wherein generating a second key using the first key further comprises using an encryption key and an initialization vector.

19. The computer program product of claim 15, wherein the output data string is equal in length to the input data string.

20. The computer program product of claim 15, further comprising:
computer-readable program code configured to encrypt the output data string; and
computer-readable program code configured to transmit the output data string to the device.
